(19) United States
(12) Patent Application Publication
(10) Pub. No.: US 2008/0156998 A1
(43) Pub. Date: Jul. 3, 2008

(54) Focused Ion Beam Apparatus

(76) Inventor: Yasuhiko Sugiyama, Chiba-shi (JP)

Correspondence Address: BRINKS HOFER GILSON & LIONE, P.O. BOX 10395, CHICAGO, IL, 60610, US

(21) Appl. No.: 11/961,967

(22) Filed: Dec. 20, 2007

(30) Foreign Application Priority Data
Dec. 28, 2006 (JP) JP2006-354789

(51) Int. Cl. H01J 3/14

(52) U.S. Cl. 250/396 R

(57) ABSTRACT

A focused ion beam apparatus including a plasma type gas ion source for generating an ion beam, and an ion optical system for gathering the ion beam generated from the plasma type gas ion source onto a sample. The ion optical system is constructed by a constitution having 2 pieces of basic electrostatic lenses and an ion optical system magnification of the 2 pieces of basic electrostatic lenses is set to be equal to or smaller than 1/300.

This application claims priority under 35 U.S.C. §119 to Japanese Patent Application No. JP2006-354789 filed Dec. 28, 2006, the entire content of which is hereby incorporated by reference.

### BACKGROUND OF THE INVENTION

The present invention relates to a focused ion beam apparatus, particularly to a focused ion beam apparatus using a plasma type gas ion source as an ion source.

In a background art, in carrying out extremely fine observation or working for a sample of a photo mask or the like, a focused ion beam apparatus is used. Further, the focused ion beam apparatus is used by switching a beam current in order to deal with a broad application.

For example, when high resolution observation or nanometer working is carried out, the observation or working is carried out by using a beam current equal to or lower than 0.1 pA, further, when high accuracy working of finishing a TEM sample or correcting a photo mask or the like is carried out, the working is carried out by using a beam current of 0.1 pA through 20 pA, further, when intermediate working of a TEM sample is carried out, the working is carried out by using a beam current of 100 pA through 1 nA, further, when working of a large area (for example, a rectangular region having one side of 100 μm) or roughening of a TEM sample is carried out, the working is carried out by using a beam current of 1 nA through 50 nA.

Meanwhile, as an ion source of a focused ion beam apparatus, in a background art, Ga liquid metal is generally used. However, when Ga liquid metal is used, the following problem is posed.

That is, Ga constitutes a contamination source for a silicon device. Therefore, when a focused ion beam constituting an ion source by Ga liquid metal is irradiated to a silicon wafer even by once, it is difficult to return the irradiated silicon wafer again to a production line in view of maintaining quality. Further, when the photo mask is corrected, there poses a problem that transmittance of light is reduced by Ga struck to a correcting portion. The problem becomes a further considerable problem in recent years since short wave formation of an exposure light source is promoted.

JP-A-7-320670 or JP-A-6-342638 proposes a focused ion beam apparatus utilizing a gas ion source as an ion source in place of Ga liquid metal as the apparatus resolving the above-described problem.

That is, the publications describe a technology of generating an ion beam by utilizing a gas ion source, chipping off a predetermined portion from a silicon wafer by using the ion beam and returning the silicone wafer as chipped off to an original line.

Meanwhile, according to the focused ion beam apparatus utilizing the gas ion source as described in Patent Reference 1 or Patent Reference 2, there poses a problem that in comparison with a case of using the ion source of the Ga liquid metal, a beam diameter cannot be narrowed and extremely fine observation or working cannot be carried out.

A detailed explanation will be given thereof as follows.

TABLE 1

| | source | | energy | angle current | |
|---|---|---|---|---|---|
| ion source type | size | | spread | density | |
| Ga liquid metal ion source | 40 | nm | 5 eV | 17 | μA/sr |
| ICP ion source | 7.2 | μm | 6.7 eV | 7.2 | mA/sr |

Table 1 shows a comparison between an ion source utilizing Ga liquid metal, and an ion source utilizing ICP (Inductively coupled plasma) constituting an example of a gas ion source.

The ICP ion source is characterized in that a source size thereof is larger than that of the Ga liquid metal ion source, further, although an energy spread does not differ therebetween, an angular current density thereof is far larger than that of the Ga liquid metal ion source.

Meanwhile, a beam diameter D of the focused ion beam apparatus is calculated by the following equation (1).

D=SQR((M·ds)²+(½Cs·αi³)²+(Cc·αi·ΔE/E)²) (1)

M: ion optical system magnification
Ds: source size
Cs: spherical aberration coefficient
αi: beam opening semi angle (image face side)
Cc: chromatic aberration coefficient
ΔE: energy spread
E: ion beam energy

Further, a beam current I is calculated by the following equation (2).

I=(dI/dΩ)π(αo)² (2)

dI/dΩ: angular current density
π: circle ratio
αo: beam opening semi angle (ion source side)

Further, the beam opening semi angle (image face side) αi is calculated by following equation (3).

αi=(1/M)(Vo/Vi)^{1/2}αo (3)

FIG. 10 shows a relationship between the beam current I and the beam diameter D calculated by using the relationships (1), (2). The ICP ion source is provided with the angular current density larger than that of the Ga liquid metal ion source by digits, and therefore, as is known from equation (2), the beam opening semi angle αo on the ion source side may be small in order to achieve the same beam current I. This signifies that a contraction ratio 1/M can be increased without reducing the beam current I.

Further, FIG. 10 tabulates both cases of crossover and noncrossover. Here, crossover refers to a case of intersecting a beam by once or more until an ion beam emitted from a extraction nozzle reaches a sample, conversely, noncrossover refers to an ion beam focused to one point after a time point of reaching a sample without intersecting even once until the ion beam emitted from the extraction nozzle reaches the sample as shown in FIG. 2.

Further, according to the table, in a case of crossover, the ion optical system magnification M is changed in a range of 0.033 through 0.09. In a case of noncrossover, the ion optical system magnification M is changed in a range of 0.2 through 0.5.

As is known from FIG. 10, in either of crossover and noncrossover, the beam diameter D of the ICP ion source stays constant relative to the beam current I. This is because a contribution of a first term (M·ds) is large in the equation (1) of calculating the beam diameter D.

As is apparent from the equation (1), when the ion optical system magnification M is small, the beam diameter D is reduced, however, in a case of using the ICP ion source, even when the ion optical system magnification M is assumedly made to be 0.033, that is, 1/30, it is insufficient. That is, as is known from FIG. 10, the beam diameter D can only be narrowed to 240 nm. Further, even when the ion optical system magnification M is assumedly made to be 1/50, the beam diameter D is 140 nm. That is, when the ICP ion source is used, it is a limit that the beam diameter D is narrowed to about 100 nm.

Therefore, according to the focused ion beam apparatus of the background art, even when only the ion source is replaced by the ICP ion source, the beam diameter D can be narrowed at least to about 100 nm to pose a problem that an application range is much narrowed.

Specifically, working of a large area (for example, an area of a shape of a quadrangle having one side of 100 μm) or roughening of a TEM sample which is carried out under a condition of the beam diameter D of about 5 μm and beam current of 1 nA through 50 nA can be carried out, further, intermediate working of a TEM sample which is carried out under a condition of the beam diameter D of about 20 nm through 200 nm and the beam current of 100 pA through 1 nA can be carried out, however, highly accurate working and finishing of a TEM sample as well as correcting of a photo mask which are carried out under a condition of the beam diameter D of about 20 nm through 60 nm and the beam current of 5 pA through 60 pA cannot be carried out. Further, high resolution observation or nanometer working which is carried out under a condition of the beam diameter D of about 4 nm and the beam current equal to or lower than 0.1 pA cannot be carried out.

The invention has been carried out in consideration of such a situation and it is an object thereof to provide a focused ion beam capable of slenderly narrowing a beam diameter to a desired value regardless of using a gas ion source as an ion source and capable of dealing with a broad application to a degree the same as that in a case of using a Ga liquid metal ion source as an ion source.

### SUMMARY OF THE INVENTION

A focused ion beam apparatus of the invention is characterized in a focused ion beam apparatus including a plasma type gas ion source for generating an ion, and an ion optical system for gathering the ion generated from the plasma type gas ion source onto a sample, wherein the ion optical system is constructed by a constitution having 2 pieces of basic electrostatic lenses, and wherein a magnification of the ion optical system combined with the 2 pieces of basic electrostatic lenses is set to be equal to or smaller than 1/300.

According to the focused ion beam, the ion optical system magnification is set to be equal to or smaller than 1/300, and therefore, as is known from the equation (1), the beam diameter can be narrowed slenderly to the desired value by an amount of reducing the ion optical system magnification. Thereby, a broad application to a degree the same as that in a case of using a Ga liquid metal ion source as an ion source can be dealt with.

Incidentally, according to the focused ion beam apparatus utilizing the Ga liquid metal ion source of the background art, the ion optical system magnification is set to about 1/50 through 1/10, and the beam diameter is not narrowed slenderly. This is because a source size of the ion source is inherently small, and therefore, it is not necessary to narrow the beam diameter.

Further, the ion optical system magnification combined with 2 pieces of the basic electrostatic lenses is set to be equal to or smaller than 1/300, and in comparison with the case of combining 3 pieces or more of basic electrostatic lenses, a number of the lenses is small and the total constitution can be simplified by that amount.

According to the focused ion beam of the invention, it is preferable that in one of the 2 pieces of basic electrostatic lenses, an acceleration voltage of the ion is set to be 10 times as much as an incident energy.

Thereby, the ion optical system magnification combined with 2 pieces of the basic electrostatic lenses can easily be set to be equal to or smaller than 1/300.

According to the focused ion beam of the invention, it is preferable that the ion optical system includes an auxiliary electrostatic lens other than the basic electrostatic lens.

Thereby, the ion optical system magnification can variously be changed. For example, the ion optical system magnification can be set to a small value of about 1/1000, or can be set to a large value of about 1/10 through 1/80. That is, a degree of freedom of setting the ion optical system magnification can be promoted.

### Advantage of the Invention

According to the invention, the beam diameter can be narrowed to the desired value although the plasma type gas ion source is used as the ion source. Thereby, a broad application to a degree the same as that of the case of using the Ga liquid metal ion source as the ion source can be dealt with.

Further, since the plasma type gas ion source is used, the problem of Ga contamination in a silicon wafer or the problem of the reduction in the transmittance in correcting a photo mask is not posed.

### BRIEF DESCRIPTION OF THE DRAWINGS

FIG. 1 is an outline view showing a total constitution of a first embodiment of a focused ion beam apparatus according to the invention.

FIG. 2 is an outline view showing a structure at and after a sampling interface of the first embodiment.

FIG. 3 is a diagram showing a relationship between a potential of an ion and a contraction rate in passing a condenser lens according to the first embodiment.

FIG. 4 is a diagram showing a relationship between a beam current and a beam diameter when an ion optical system magnification is variously changed according to the first embodiment.

FIG. 5 is an outline view showing a structure at and after a sampling interface of a second embodiment of a focused ion beam apparatus according to the invention.

FIG. 6 is a diagram showing a relationship between a beam current and a beam diameter when an ion optical system magnification is variously changed according to the second embodiment.

FIG. 7 is a schematic view showing an outline of an ion beam showing a modified example of the second embodiment.

FIG. 8 is a diagram showing a relationship between a beam current and a beam diameter according to the modified example.

FIG. 9 is an outline view showing a constitution of other embodiment of the invention.

FIG. 10 is a diagram showing a relationship between a beam current and a beam diameter of a focused ion beam apparatus of a background art.

### DETAILED DESCRIPTION OF THE PREFERRED EMBODIMENTS

Respective embodiments of a focused ion beam apparatus according to the invention will be explained in reference to the drawings as follows.

### First Embodiment

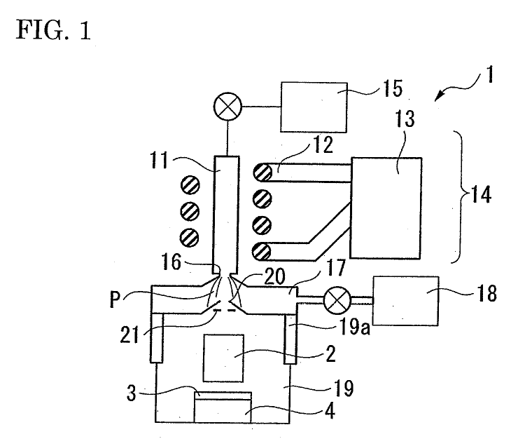

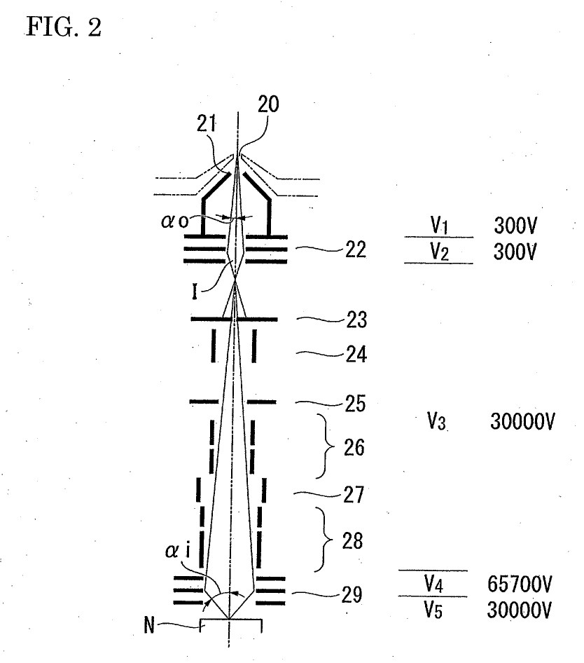

FIG. 1 through FIG. 4 show a first embodiment of a focused ion beam apparatus, FIG. 1 is a view showing an outline constitution of a total of the apparatus, and FIG. 2 is a view showing a structure at and after a sampling interface.

In FIG. 1, notation 1 designates a plasma type gas ion source. A downstream side (lower side in FIG. 1) of the plasma type gas ion source 1 is provided with an ion optical system 2 for focusing an ion beam emitted from the plasma type gas ion source 1. On a lower side of the ion optical system 2, a sample base 3 for mounting a sample N constituting an object of working or an object of observation is supported movably by an XYZ stage 4 which is operated in three axes directions orthogonal to each other respectively independently from each other.

The plasma type gas ion source 1 includes an inductively coupled plasma generator 14 having a plasma torch 11, a work coil 12 arranged to surround the plasma torch 11, and a high frequency power source 13 connected to the work coil 12, a gas supply portion 15 for supplying argon gas, xenon gas, or hydrogen gas to the plasma torch 11, and a torch orifice 16 at a portion thereof coupled with the plasma torch 11 provided on a lower side of the plasma torch 11, and includes a differential exhaust chamber 17 for extracting a plasma generated by the inductively coupled plasma generator 14 from the torch orifice 16 as a plasma jet stream. The differential exhaust chamber 17 is connected with a vacuum pump 18 for lowering an inner portion of the differential exhaust chamber 17 to a predetermined vacuum atmosphere.

Further, in FIG. 1, notation 19 designates a vacuum chamber which can be lowered to a predetermined vacuum pressure by a vacuum forming system, not illustrated, and the vacuum chamber 19 is electrically insulated from the differential exhaust chamber 17 by an insulating member 19a.

The structure at and after the sampling interface will be explained in reference to FIG. 2. A bottom plate of the differential exhaust chamber 17 is provided with a extraction orifice 20 at a position in correspondence with the torch orifice 16, and on a lower side of the extraction orifice 20, a extraction electrode 21 is arranged. Further, the ion optical system 2 is arranged on a lower side of the extraction electrode 21.

The ion optical system 2 includes a condenser lens (basic electrostatic lens) 22, a diaphragm 23, a beam blanker 24, a blanking diaphragm 25, a beam alignment electrode 26, an astigmatism corrector 27, a scanning electrode 28, and an object lens (basic electrostatic lens) 29 in order from the extraction orifice 20 side toward the sample base 3 side.

The condenser lens 22 is for focusing an ion beam I emitted from the extraction orifice 20, and comprises an einzel lens constituted by 3 sheets of electrodes 22a, 22b, 22c. The 3 sheets of electrodes 22a, 22b, 22c are respectively formed with through holes to thereby form an incident port and an emitting port. Further, the diaphragm 23 is for narrowing the passing ion beam I. Further, the beam blanker 24 is for switching the ion beam I to ON or OFF. The blanking diaphragm 25 is for narrowing the passing ion beam I further to a predetermined diameter.

The beam alignment electrode 26 is constituted by, for example, 2 stages by a plurality of electrodes aligned substantially in a cylindrical shape for correcting a deviation of an optical axis of the passing ion beam I by applying voltages to the respective electrodes independently from each other. Further, the astigmatism corrector 27 is constituted by a plurality of electrodes aligned substantially in a cylindrical shape for correcting a distortion of a sectional shape of the passing ion beam I, that is, correcting an astigmatism by applying voltages to respective electrodes independently from each other. Further, the scanning electrodes 28 are constituted by a plurality of electrodes aligned substantially in a cylindrical shape and can scan a position of irradiating the ion beam I on the sample N freely in X-axis direction and Y-axis direction orthogonal to each other by applying voltages to the respective electrodes independently from each other.

The object lens 29 is for focusing the ion beam I focused, reflected, corrected or the like by the above-described constitution finally onto the sample and is the einzel lens constituted by 3 sheets of electrodes 29a, 29b, 29c similarly to the condenser lens 22.

Here, a magnification M of the ion optical system combined with the condenser lens 22 and the object lens 29 is set to be equal to or smaller than 1/300. Specifically, the magnification is set to 1/360 according to the first embodiment.

Further, an acceleration voltage of an ion at the condenser lens 22 will be described in details in the explanation of operation mentioned later.

Next, the operation of the focused ion beam apparatus having the above-described constitution will be explained. A high frequency magnetic field is applied to the plasma torch 11 by the work coil 12, and at the plasma torch 11, a plasma is generated and maintained by ionizing an inert gas. A portion of the plasma is made to flow from the torch orifice 16 to a side of the differential exhaust chamber 17 by a pressure difference while forming a supersonic plasma jet stream P. At inside of the plasma jet stream P, the extraction orifice 20 is arranged, and an ion and an electron are emitted from the extraction orifice 20. Further, the ion having a large mass is provided with a high straight advancing property, and therefore, the ion is incident on the condenser lens 22 while being accelerated by an electric field produced by the extraction electrode 21 as it is.

The ion beam I incident on the condenser lens 22 is accelerated and focused there, thereafter, reaches the object lens 29 by way of the diaphragm 23, the beam blanker 24, the blanking diaphragm 25, the beam alignment electrode 26, the astigmatism corrector 27, and the scanning electrode 28 and is irradiated onto a surface of the sample N by way of the object lens 29.

Here, according to the first embodiment, as shown by FIG. 2, a potential of the ion passing through respective regions of the focused ion beam apparatus is set to a predetermined value by setting voltages applied to electrodes of the condenser lens 22 and the object lens 29 as well as the beam blanker 24, the blanking diaphragm 25 and the like to pertinent values.

For example, as shown by FIG. 2, when a potential in passing the extraction electrode 21 is set to V1, a potential in passing the condenser lens 22 is set to V2, a potential in passing intermediate electrodes of the beam blanker 24 and the beam alignment and the like is set to V3, a potential in passing the object lens 29 is set to V4, and a potential in being incident on the sample is set to V5, the electrodes are respectively set such that the potentials are provided with the following values.

V1: 300V, V2: 300V, V3: 30000V, V4: 65700V, V5: 30000V,

By setting the potentials of the ion at respective regions to the predetermined values in this way and by other various elements, the ion optical system magnification M is set to 1/360.

Incidentally, according to the focused ion beam apparatus of the background art using a Ga liquid metal ion as an ion source, it is general that the potential V1 in passing the extraction electrode 21 and the potential V2 in passing the condenser lens 22 are respectively set to 5000V through 8000V, and the potential V3 in passing the intermediate electrodes is set to about 30000V. Therefore, according to the focused ion beam apparatus of the background art, V3/V2 is about 5 through 6 magnifications. In contrast thereto, according to the focused ion beam apparatus of the first embodiment, V3/V2 can be set to a large ratio of 100. This signifies that a focal length by the condenser lens 22 can be set to be more proximate, and stronger focusing operation can be achieved.

Further, by changing a voltage applied to the condenser lens 22, the potential V2 of the ion in passing the condenser lens 22 can variously be changed, thereby, the ion optical system magnification M can finely be adjusted.

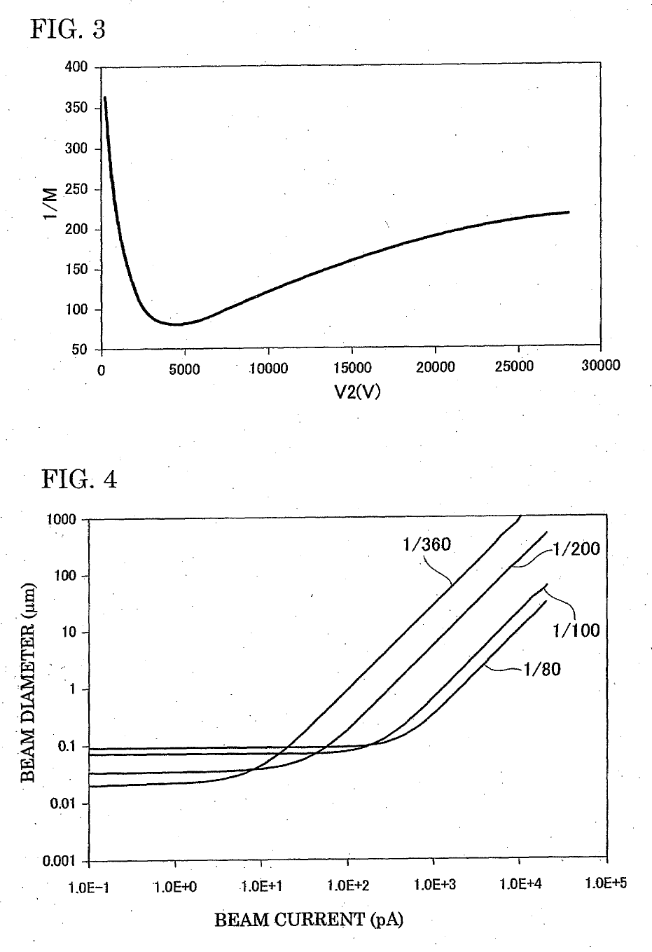

FIG. 3 shows the adjustment. That is, in FIG. 3, the ordinate designates a contraction rate 1/M, and the abscissa designates the potential V2 of the ion in passing the condenser lens 22.

As is known from the drawing, when V2 is changed from 300V to 28000V, the contraction rate 1/M is gradually reduced from starting 360, and when V2 is 4000V, the contraction rate 1/M is reduced to about 60. Thereafter, when V2 is increased, the contraction rate 1/M is gradually increased in accordance with the increase and is increased to about 210 when V2 is 25000V.

Further, it is known that when the potential V3 in passing the intermediate electrodes is set to about 30000V, and the potential V1 in passing the extraction electrode 21 and the potential V2 in passing the condenser lens 22 are respectively set to 150V, 1/M can be set to 484 and when the potentials V1, V2 are set to 200V, 1/M can be set to 433.

FIG. 4 shows a relationship between the beam current and the beam diameter when the ion potential V1 in passing the extraction electrode 21 is set to 300V. In FIG. 4, the ordinate designates the beam diameter, and the abscissa designates the beam current.

As is apparent from the drawing, by setting the ion optical system magnification M to 1/360, the beam diameter can be set to 20 nm when the beam current is 1 pA. Further, it is known that in accordance with the increase in the beam current, a smaller beam diameter can be achieved by lowering the contraction rate 1/M from 360 to 200, 100, 80.

### Second Embodiment

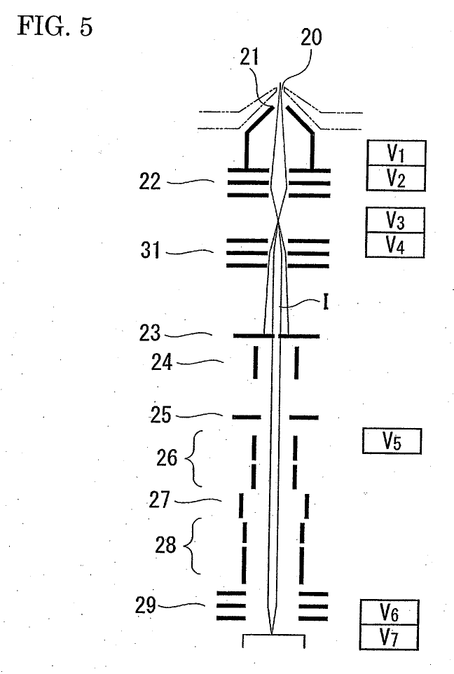

FIG. 5 shows a structure of a portion (at and after sampling interface) of a second embodiment of a focused ion beam apparatus according to the invention. Further, in order to simplify the explanation, when a constitution element the same as other constituent element used in the first embodiment is used, the constituent element is attached with the same notation and an explanation thereof will be omitted.

A point of a difference of the second embodiment from the first embodiment resides in that a condenser lens 31 as an auxiliary electrostatic lens is provided between the two lenses 22, 29 other than the condenser lens 22 and the object lens 29 constituting the basic electrostatic lenses.

Further, also in the second embodiment, a plasma gas type ion source is naturally provided as an ion source.

By providing the condenser lens 31 constituting the auxiliary electrostatic lens in this way, a range of controlling the ion optical system magnification M can be widened, further, thereby, in comparison with the focused ion beam apparatus shown in the first embodiment, a small beam diameter can be achieved in a region of a larger beam current.

The range is shown in FIG. 5. In FIG. 5, the ordinate designates the beam diameter, and the abscissa designates the beam current.

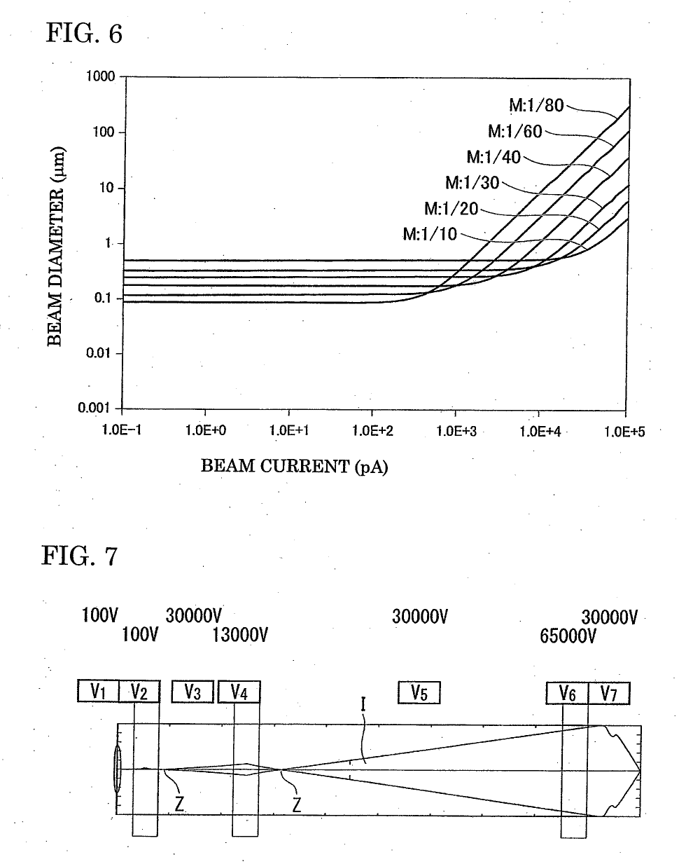

As is known by comparing FIG. 6 and FIG. 5, in FIG. 5, when the ion optical system magnification M is 1/80, the beam diameter is 300 μm at the beam current of 1 nA, further, the beam diameter is 10 μm at the beam current of 10 nm. In contrast thereto, in FIG. 6, when the ion optical system magnification M is 1/60, the beam diameter is 180 μm at the beam current of 1 nA, and when the ion optical system magnification M is 1/20, the beam diameter is 400 μm at the beam current of 1 nA.

That is, when the beam current is in a nano order, the beam diameter can be reduced by increasing the ion optical system magnification M to a pertinent value.

### Modified Example

FIG. 7 shows a modified example of the second embodiment of a focused ion beam apparatus according to the invention.

According to the example, a situation when the beam diameter is narrowed the most in a small current region is assumed.

That is, here, when the potential V1 in passing the extraction electrode 21 is set to 100V, the potential V2 in passing the condenser lens 22 is set to 100V, the potential V3 in passing the intermediate region from the condenser lens 22 until reaching the condenser lens 31 on a lower side thereof is set to 30000V, the potential V4 in passing the condenser lens 31 is set to 13000V, the potential V5 in passing the intermediate electrodes of the condenser lens, the beam blanker, the beam alignment and the like is set to 30000V, the potential V6 in passing the object lens 29 is set to 65000V, and the potential V7 of being incident on the sample is set to 30000V, as shown by notation Z in FIG. 7, there are crossovers at two portions and the contraction rate 1/M at this occasion becomes 1000.

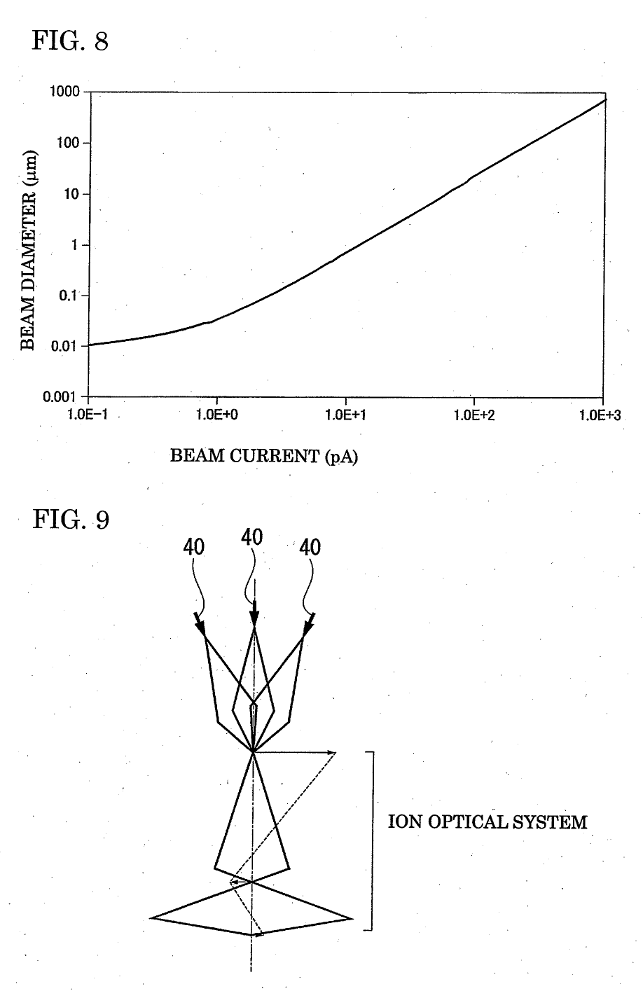

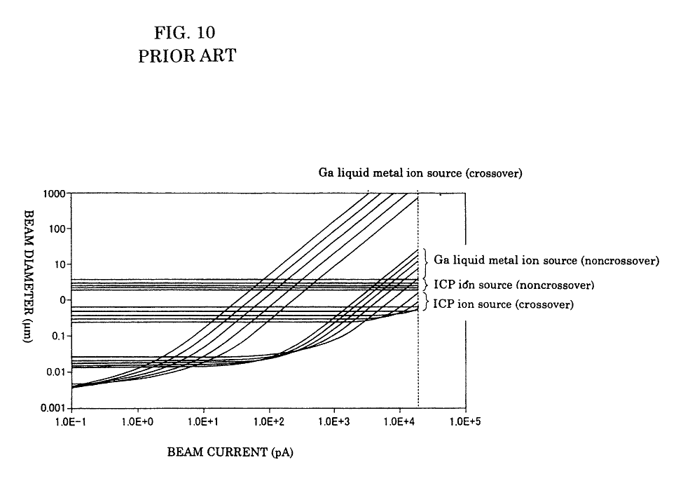

FIG. 8 shows a relationship between the beam diameter and the beam current at this occasion. In FIG. 8, the ordinate designates the beam diameter, and the abscissa designates the beam current.

As is known from FIG. 8, when the beam current is 0.1 pA, the beam diameter of 10 nm is achieved. That is, high resolution observation or nanometer working or the like which needs a condition that the beam diameter D is about 4 nm, and the beam current is equal to or smaller than 0.1 pA can be carried out by using the plasma gas type ion source as the ion source.

Further, the technical range of the invention is not limited to the above-described embodiments but can be variously be modified within the range not deviated from the gist of the invention.

For example, although according to the respective embodiments, an explanation has been given by taking an example of the apparatus having one ion source, as shown by FIG. 9, the invention is applicable also to a case having a so-to-speak multi type ion source having a plurality of ion sources 40 including focusing lenses.

Further, as a sample worked or observed in the ion beam apparatus according to the invention, the sample may naturally be a photo mask or a TEM sample.

What is claimed is:

1. A focused ion beam apparatus characterized in a focused ion beam apparatus comprising:
a plasma type gas ion source for generating an ion; and
an ion optical system for gathering the ion generated from the plasma type gas ion source onto a sample;
wherein the ion optical system is constructed by 2 pieces of basic electrostatic lenses; and
wherein a magnification of the ion optical system combined with the 2 pieces of basic electrostatic lenses is set to be equal to or smaller than 1/300.

2. The focused ion beam apparatus according to claim 1, in one of the 2 pieces of basic electrostatic lenses, an acceleration voltage of the ion is set to be 10 times as much as an incident energy.

3. The focused ion beam apparatus according to claim 1, wherein the ion optical system includes an auxiliary electrostatic lens.

4. The focused ion beam apparatus according to claim 2, wherein the ion optical system includes an auxiliary electrostatic lens.
